(19) United States
(12) Patent Application Publication
(10) Pub. No.: US 2014/0301906 A1
(43) Pub. Date: Oct. 9, 2014

(54) Three Way Catalyst Double Impregnation Composition and Method Thereof

(71) Applicant: Randal Hatfield, Camarillo, CA (US)

(72) Inventor: Randal Hatfield, Camarillo, CA (US)

(73) Assignee: CDTI, Ventura, CA (US)

(21) Appl. No.: 13/856,884

(22) Filed: Apr. 4, 2013

(51) Int. Cl. B01D 53/94

(52) U.S. Cl. CPC B01D 53/945
USPC 422/168; 422/180; 427/380; 427/374.1

(57) ABSTRACT

A double impregnation method and composition for producing three way catalysts (TWC) are disclosed. The TWC may generally include a substrate, a washcoat, a first and second impregnation compositions, and optionally at least an overcoat over the impregnation compositions. The first impregnation composition may include a composition of a perovskite, base metal oxides, and alkaline earth carbonates. The method for applying the first impregnation composition may include combining all base metals in the composition, adding Pd, drying, and adding a heat treatment. The method for applying the second impregnation composition may include adding a remainder of Pd as a Pd solution over the first impregnation, drying, and applying a heat treatment.

### CROSS-REFERENCE TO RELATED APPLICATIONS

The present application is related to U.S. Pat. No. 7,641,875 B1, entitled “Mixed-phase ceramic oxide three-way catalyst formulations and methods for preparing the catalysts”.

### BACKGROUND

1. Field of the Disclosure

The present disclosure relates generally to catalytic converters, and more particularly to catalyst compositions and methods for fabricating the catalyst.

2. Background Information

Three way conversion, the simultaneous conversion of nitrogen oxides (NOx), carbon monoxide (CO), and hydrocarbons (HC), is desirable in order to meet emission standards for automobiles and other vehicles. For achieving an efficient three-way conversion, conventional three way catalysts (TWCs) include precious metals, particularly platinum group metals (PGMs), such as Pd, Pt, and Rh, dispersed on suitable oxide carriers in conjunction with other materials on the catalyst.

Methods that may be utilized to make TWCs may include spray drying, precipitation, impregnation, incipient wetness, ion exchange, fluid bed coating, and physical or chemical vapor deposition, among others; one or more of these methods are described by patents U.S. Pat. No. 7,641,875 B1, U.S. 2009/0324470 A1, U.S. Pat. No. 4,780,447, U.S. Pat. No. 4,727,052, and U.S. 2008/0233039 A1, among others.

Among these methods, one of the most generally used may include incipient wetness, in which an active metal precursor may be dissolved in an aqueous or organic solution. Then, the metal-containing solution may be added to a catalyst support with the same pore volume as the volume of the solution that was added, such that capillary action may draw the solution into the pores. The catalyst can then be dried and calcined to drive off volatile components within the solution, depositing the metal on the catalyst surface. The maximum loading is limited by the solubility of the precursor in the solution. The catalyst may include any suitable form, such as, pellets, granular, powder, in a fixed or fluidized bed, monolith, and coated monolith, among others.

Impregnation has come as a more efficient method for producing TWCs, in which a substrate is coated employing techniques such as waterfall coating, with a washcoat including alumina or oxygen storage materials for supporting PGMs. Subsequently, the substrate with the washcoat are impregnated with PGMs and are then fired. In other cases, the impregnation includes base metals, and more than one impregnation may be deposited on the washcoat. Problems associated with impregnation include precipitation of elements within the impregnation compounds when higher catalytic levels are desired, because this includes exceeding the solubility level of the compounds, leading to precipitation of catalyst precursors, which can lead to poor PGM dispersion.

When TWCs are exposed to high-temperature exhaust gas (particularly, 800° C. or higher), catalytic activity may be lowered because particles of PGMs are aggregated and consequently sintering may occur, decreasing the active surface area of TWCs. Surface area is important because the greater the surface area is, the more catalytic material is exposed to reactants, resulting in a higher rate of catalytic reactions employing less time and catalytic materials. It is also known in the art to stabilize the alumina against such thermal degradation by the use of materials such as zirconia, titania, alkaline earth metal oxides such as baria, calcia or strontia or, most usually, rare earth metal oxides, such as, ceria, lanthana and mixtures of two or more rare earth metal oxides, making the TWC more costly.

There is a deep interest to improve TWC manufacturing techniques to lower the level of PGM usage while increasing catalytic activity and surface area in these catalysts.

### SUMMARY

The present disclosure describes a composition and a method for a double impregnation technique that may be applied for producing a three way catalyst (TWC) catalytic converter. TWCs may be generally mounted in an exhaust pipe of an engine for oxidation of carbon monoxide to carbon dioxide, hydrocarbons to water and carbon dioxide, and reduction of nitrogen oxides (NOx) to carbon dioxide (CO), nitrogen, and water.

The present TWC may include a substrate, a washcoat, a first impregnation composition, a second impregnation composition, and optionally at least an overcoat. The substrate may include any suitable material known in the art for three way catalysts. The washcoat may include oxide solids with a mixture of carrier material oxides and one or more catalysts. The first impregnation solution may contain a portion of the PGMs and most of the base-metal additives. Additionally, the first impregnation may include precursors to form a mixed oxide and/or carbonate which may include a composition of a perovskite, base metal oxides, and alkaline earth carbonates. Yet more particularly, the first impregnation composition may comprise a material including one or more selected from the group consisting of Ba, Ce, Nd, Sr and Pd. The second impregnation composition may comprise a material including one or more selected from the group consisting of Ba, Ce, Nd, Sr and Pd.

The perovskite may have the general formula ABO₃, where A and B are cations of very different size and O is an oxide anion that bonds to both A and B. Suitable elements for the A site may include Sr, Ba, La, Nd, Pr, and combinations thereof; suitable elements for the B site may include La, Nd, Pr, Pd, Mn, Co, PGMs, and combinations thereof. Suitable combinations for the perovskite may include BaCeO₃, NdBaCeO₃, BaCeNdO₃, SrLaMnPdO₃, and BaLaMnPdO₃, among others. Depending on the preparation and use conditions the perovskite can be oxygen deficient.

The base metal oxides may include oxides of Mg, Ca, Sr, Ba, Mn, Zn, Zr, Ce, Pr, Nd, Ni, Co, Fe, Pd, and rare earth element mixed oxides, among others. For example, suitable combinations of base metal oxides may include CeO₂, CeZrO₂, CeZrO₂ doped with rare earth elements, NdCeO₂, and PdCeO₂, among others. Suitable structures for the base metal oxides may include perovskite, among others.

The alkaline earth carbonates may include suitable materials such as BaCO₃ and SrCO₃, among others, with suitable structures such as witherite, among others.

The method for applying the first impregnation composition may include combining all base metals in the composition, adding Pd, drying, and applying a heat treatment. The method for applying the second impregnation composition may include adding the remainder of Pd as a Pd solution over the first impregnation, drying, and applying a heat treatment. For example, the washcoat may include a first impregnation composition including materials selected from the group of Ba, Ce, Nd, Sr, and Pd, and more particularly may include PdNO₃.

Employing the methods and compositions described in the present disclosure may inhibit sintering of material phases, improving surface area of catalysts within the TWC, enhancing the catalytic activity by creating multiple PGM environments, and/or minimizing the use of precious metals such as platinum group metals. Additionally, the methods and compositions of double impregnation from the present disclosure may reduce problems of precipitation that may normally result when employing a single impregnation.

### LIST OF FIGURES

FIG. 1 is a configuration of a three way catalyst (TWC) catalytic converter, according to an embodiment.

FIG. 2 is a mixed phase catalyst (MPC) structure, according to an embodiment.

FIG. 3 is a flowchart of a double impregnation technique, according to an embodiment.

FIG. 4 is a TWC Light-off Test T 90's 400 (90% conversion) comparing a T5152 standard TWC with a T5158 TWC, according to an embodiment.

FIG. 5 shows a TWC conversion test at 400° C. comparing a T5152 standard TWC with a T5158 TWC, according to an embodiment.

FIG. 6 is an isothermal oscillating test at 400° C. comparing a T5152 standard TWC with a T5158 TWC, according to an embodiment.

FIG. 7 is a sweep cross-over conversion test at 370° C. comparing a T5152 standard TWC with a T5158 TWC, according to an embodiment.

### DETAILED DESCRIPTION

Definitions

As used herein, the following terms have the following definitions:

“Three way catalyst” or “TWC” refers to a catalytic converter that simultaneously reduces nitrogen oxides to nitrogen and oxygen, oxidizes carbon monoxide to carbon dioxide, and oxidizes unburnt hydrocarbons to carbon dioxide and water.

“Impregnation composition” refers to one or more components including at least a catalyst that may be added to a washcoat and/or overcoat.

“Double impregnation method” refers to a technique used for adding two different PGM environments by using two different impregnation solution compositions over a washcoat and/or overcoat.

“Oxide solid” refers to materials including those selected from the group of at least carrier material oxide, a catalyst, and/or a mixture thereof.

“Base metals” refers to industrial non-ferrous metals included in oxide solids, excluding precious metals such as platinum group metals (PGM).

“Carrier material oxide” refers to support materials used for providing a surface for at least one catalyst.

“Catalyst” refers to materials employed for conversion of at least hydrocarbons, carbon monoxide, and nitrogen oxides from exhaust gases.

“Overcoat” refers to a coating including one or more catalysts and/or carrier material oxides.

### DESCRIPTION OF THE DRAWINGS

The present disclosure is hereby described in detail with reference to embodiments illustrated in the drawings, which form a part hereof. In the drawings, which are not necessarily to scale or to proportion, similar symbols typically identify similar components, unless context dictates otherwise. Other embodiments may be used and/or and other changes may be made without departing from the spirit or scope of the present disclosure. The illustrative embodiments described in the detailed description are not meant to be limiting of the subject matter presented.

TWC Configuration

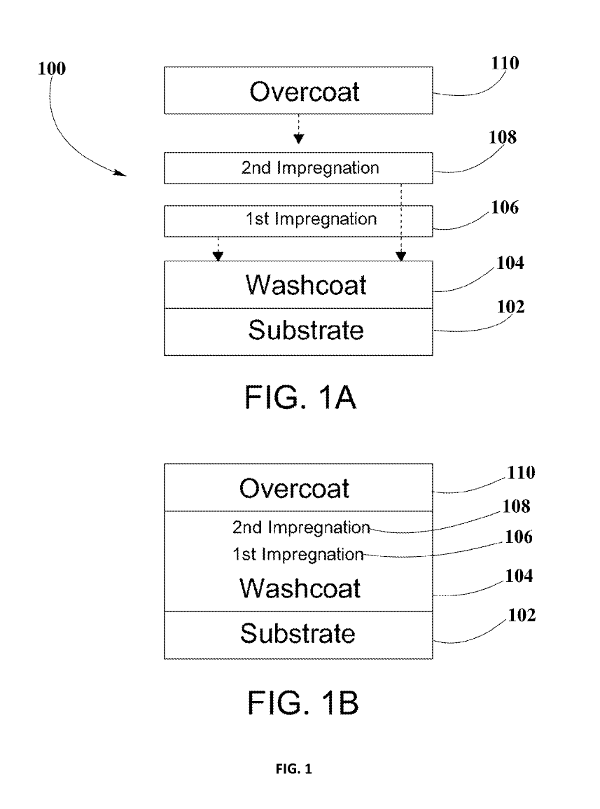

FIG. 1 shows a configuration a three way catalyst (TWC 100) catalytic converter that may generally be mounted in an exhaust pipe of an engine for oxidation of carbon monoxide to carbon dioxide, hydrocarbons to water and carbon dioxide, and reduction of nitrogen oxides (NOx) to carbon dioxide, nitrogen, and water.

FIG. 1A shows Substrate 102; a Washcoat 104 over Substrate 102; a First Impregnation Composition 106 over Washcoat 104, which is absorbed by Washcoat 104 and makes a part thereof; a Second Impregnation Composition 108, which is deposited over Washcoat 104 after drying and heating First Impregnation Composition 106, and which is absorbed by Washcoat 104 and makes a part thereof; and optionally at least an Overcoat 110, which may be deposited over Washcoat 104 that has been combined with First Impregnation Composition 106 and Second Impregnation Composition 108. Other suitable configurations for TWC 100 may additionally be employed.

FIG. 1B shows Substrate 102, Washcoat 104 combined with First Impregnation Composition 106 and with Second Impregnation Composition 108, and optionally at least an Overcoat 110 over Washcoat 104.

Mixed phase catalysts (MPC) may be used in Washcoat 104, First Impregnation Composition 106, and Second Impregnation Composition 108, to form a TWC 100 with higher surface area for more efficient catalytic activity, and with less precious metals.

Substrate 102 may be a refractive material, a ceramic substrate, a honeycomb structure, a metallic substrate, a ceramic foam, a metallic foam, a reticulated foam, or suitable combinations, where Substrate 102 may have a plurality of channels and a suitable porosity. Substrate 102, either metallic or ceramic, may offer a three-dimensional support structure.

According to an embodiment, Substrate 102 may be in the form of beads or pellets, or any other suitable form. Substrate 102 may be formed from any suitable material, including alumina, silica alumina, silica, titania, and mixtures thereof. In another embodiment, Substrate 102 may be a ceramic honeycomb substrate or a metal honeycomb substrate. The ceramic honeycomb substrate may be formed from any suitable material, including sillimanite, zirconia, petalite, spodumene (lithium aluminum silicate), magnesium silicates, mullite, alumina, cordierite (e.g. Mg2A14Si5O18), other alumino-silicate materials, silicon carbide, aluminum nitride, and combinations thereof. The metal honeycomb substrate may be formed from a heat-resistant base metal alloy, particularly an alloy that includes iron.

According to an embodiment, Substrate 102 may be a monolithic carrier having a plurality of fine, parallel flow passages extending through the monolith. The passages can be of any suitable cross-sectional shape and/or size. The passages may be of any suitable shape, including trapezoidal, rectangular, square, sinusoidal, hexagonal, oval, and circular. The monolith may contain from about 9 to about 1200 or more gas inlet openings or passages per square inch of cross section, although fewer passages may be used.

Suitable oxide solids in Washcoat 104 may include a mixture of carrier material oxides and one or more catalysts. Carrier materials are porous solid oxides that are used to provide a high surface area. Carrier materials are normally stable at high temperatures and under a range of reducing and oxidizing conditions.

According to an embodiment, carrier material oxides are initially in a powder form. The carrier material oxides may be an inert powder or any other carrier material oxides known in the art for forming a Washcoat 104. Carrier material oxides may include one or more suitable materials such as oxygen storage material, aluminum oxide, doped aluminum oxide, spinel, delafossite, lyonsite, garnet, perovskite, pyrochlore, doped ceria, fluorite, zirconium oxide, doped zirconia, titanium, tin oxide, silicon dioxide, and mixtures thereof.

According to an embodiment, Washcoat 104 may be formed on Substrate 102 by suspending oxide solids in water to form an aqueous slurry and depositing the aqueous slurry on Substrate 102. Other components may optionally be added to the aqueous slurry to adjust rheology of the slurry and/or enhance binding of Washcoat 104 to Substrate 102. These other components may include acid or base solutions or various salts or organic compounds, such as ammonium hydroxide, aluminum hydroxide, acetic acid, citric acid, tetraethylammonium hydroxide, other tetralkylammonium salts, ammonium acetate, ammonium citrate, glycerol, commercial polymers such as polyethylene glycol, polyvinyl alcohol and other suitable polymers.

The slurry may be placed on Substrate 102 in any suitable manner. For example, Substrate 102 may be dipped into the slurry, or the slurry may be sprayed on Substrate 102. If Substrate 102 is a monolithic carrier with parallel flow passages, Washcoat 104 may be formed on the walls of the passages. Exhaust gas flowing through the flow passages can contact Washcoat 104 on the walls of the passages as well as materials that are supported on Washcoat 104.

After deposition, Washcoat 104 may be thermally treated at a temperature between 300° C. and 800° C., preferably about 550° C. The treating may last from about 2 to about 6 hours, preferably about 4 hours. After the treating, Washcoat 104 and Substrate 102 may be cooled to about room temperature.

After thermally treating Washcoat 104 and Substrate 102, First Impregnation Composition 106 and Second Impregnation Composition 108 may be added over Washcoat 104, with drying procedures and heat treatments after adding each impregnation composition.

TWC 100 may optionally include an Overcoat 110 with at least one oxide solid, where the oxide solid may include one or more selected from the group consisting of a carrier material oxide, a catalyst, and mixtures thereof. Catalysts in Overcoat 110 may include metals from the platinum group metals (PGM), including, ruthenium, rhodium, palladium, iridium, and platinum.

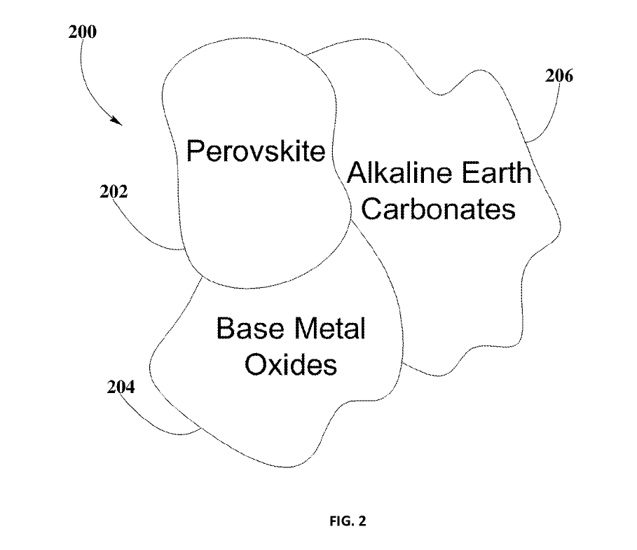

Details about materials of First Impregnation Composition 106 and Second Impregnation Composition 108 are provided in FIG. 2.

MPC Structure

FIG. 2 shows an MPC Structure 200 that may be used in First Impregnation Composition 106, according to an embodiment. Accordingly, MPC Structure 200 may include a combination of a Perovskite Structure 202, Base Metal Oxides 204, and Alkaline Earth Carbonates 206.

Perovskite Structure 202 has the general formula ABO₃, where A and B are cations of very different size and O is an oxide anion that bonds to both A and B. Generally, the A site is larger than the B site. Perovskite Structure 202 may exhibit suitable catalytic activity and surface area for providing a MPC Structure 200 with less precious metals. A large number of elements may be selected for A and B and a large number of compounds can fall within the scope of Perovskite Structure 202. According to an embodiment, suitable elements for the A site may include Sr, Ba, La, Nd, Pr, and combinations thereof; and suitable elements for the B site may include La, Nd, Pr, Pd, Mn, Co, PGMs, and combinations thereof. Suitable combinations for Perovskite Structure 202 may include BaCeO₃, NdBaCeO₃, BaCeNdO₃, SrLaMnPdO₃, and BaLaMnPdO₃, among others. Ba in the A site of Perovskite Structure 202 may improve oxygen conductivity of MPC Structure 200.

Base Metal Oxides 204 within MPC Structure 200, which may improve oxygen transport of MPC Structure 200, may include oxides of Mg, Ca, Sr, Ba, Mn, Zn, Zr, Ce, Pr, Nd, Ni, Co, Fe, Rh, and rare earth elements, among others. For example, suitable combinations of base metal oxides may include CeO₂, CeZrO₂, CeZrO₂ doped with rare earth elements, NdCeO₂, and PdCeO₂, among others. Base Metal Oxides 204 may include suitable structures such as fluorite. Nd doping Base Metal Oxides 204 may improve ionic conductivity of MPC Structure 200.

Alkaline Earth Carbonates 206 within MPC Structure 200 may include suitable materials such as BaCO₃ and SrCO₃, among others, and suitable structures including, but not limited to, witherite.

Double Impregnation Method

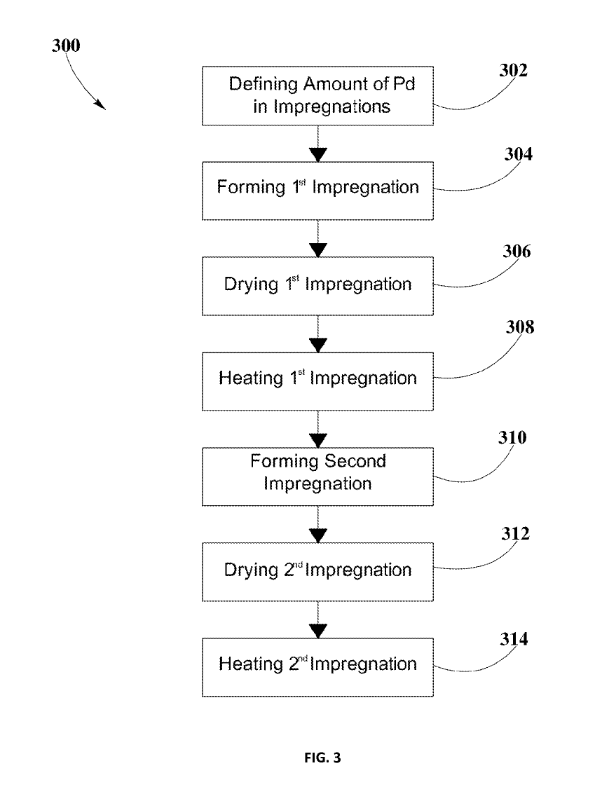

FIG. 3 is a flowchart that shows a Double Impregnation Method 300 according to the present disclosure. According to an embodiment, Double Impregnation Method 300 may include Defining an amount of Pd 302 to be within the impregnation compositions; Forming the First Impregnation Composition 304, which may include combining all the BM in MPC Structure 200 with, for example, 50 g/ft³ of Pd per 100 g/m of Washcoat 104; Drying First Impregnation Composition 306, which may include applying dry air at about room temperature to First Impregnation Composition 106 for a partial or complete drying, employing any suitable drying technique known in the art; Applying Heat to the First Impregnation Composition 308 from about 400° C. to about 800° C.; Forming the Second Impregnation Composition 310 over First Impregnation Composition 106, which may include adding remaining 50 g/ft³ of Pd (may include a solution of PdNO₃ or a solution of Pd and water) over First Impregnation Composition 106; Drying the Second Impregnation 312, which may include applying dry air at about room temperature to Second Impregnation Composition 108 for a partial or complete drying, employing any suitable drying technique known in the art; and Applying Heat to Second Impregnation Composition 314 from about 400° C. to about 700° C. Applying the methods in the present disclosure may prevent precipitation within impregnation compositions, which is a common problem related to single impregnation methods, and may increase surface area and catalytic efficiency within TWC 100.

Performance Charts

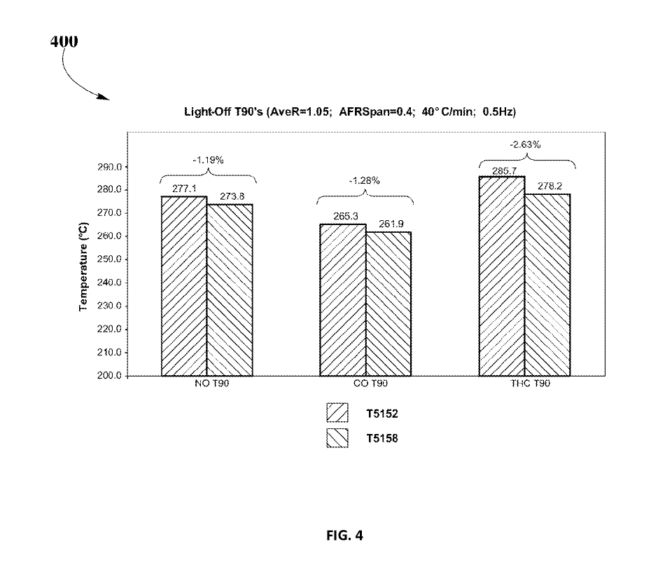

FIG. 4 shows a TWC Light-off Test T 90's 400 (90% conversion) comparing a T5152 standard TWC with a T5158 TWC 100 of the present disclosure. The T5152 TWC includes a first impregnation with ½ BM+100 g/ft³ of PdNO₃, while the second impregnation has the same composition. The T5158 TWC 100 includes a first impregnation with all BM+100 g/ft³ of PdNO₃ and a second impregnation including the remaining 100 g/ft³ PdNO₃. As may be appreciated, employing T5158 TWC 100, there is a percentage reduction in the light-off temperature of 1.19% for NO conversion, a percentage reduction of 1.28% for CO conversion, and a percentage reduction of 2.63% for THC (total hydrocarbons).

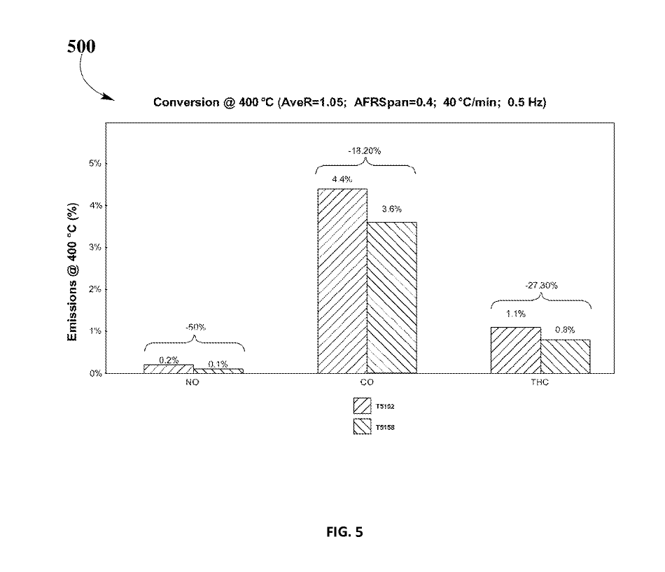

FIG. 5 shows a TWC Conversion Test 500 at 400° C. comparing a T5152 standard TWC with a T5158 TWC 100 of the present disclosure. As may be appreciated, employing T5158 TWC 100 there is a percentage reduction in NOx emissions of 50%, a percentage reduction in CO emissions of 18.20%, and a percentage reduction of 27.30% for THC emissions.

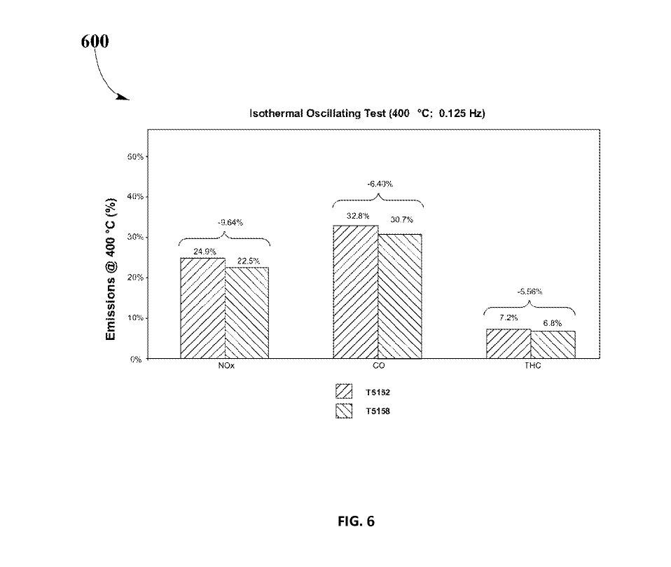

FIG. 6 shows an Isothermal Oscillating Test 600 at 400° C. comparing a T5152 standard TWC with a T5158 TWC 100 of the present disclosure. As may be appreciated, employing T5158 TWC 100 there is a percentage reduction in NOx emissions of 9.64%, a percentage reduction of 6.40% for CO emissions, and a percentage reduction of 5.56% for THC emissions.

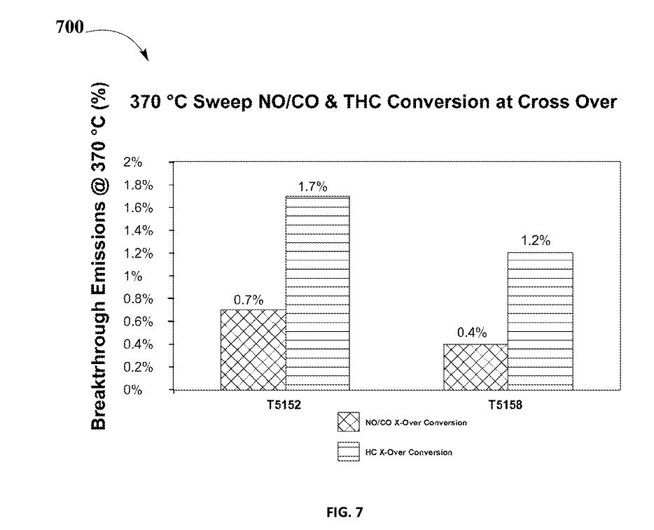

FIG. 7 shows a Sweep Cross-over Conversion Test 700 at 370° C. comparing a T5152 standard TWC with a T5158 TWC 100 of the present disclosure. Employing T5158 TWC 100 there is a percentage reduction in NO/CO X-over emissions of 42.86%, and a percentage reduction in HC X-over emissions of 29.41%.

### EXAMPLES

Example #1 is an embodiment of a different configuration of TWC 100, in which Washcoat 104 is added over Substrate 102, and both First Impregnation Composition 106 and Second Impregnation Composition 108 may be added on Overcoat 110, for subsequent heat application at about 300° C. to about 800° C., preferably about 550° C. The treating may last from about 2 hours to about 6 hours, preferably about 4 hours.

Example #2 is a formulation of Perovskite Structure 202 including (Ba)(CeNd)(O₃), in which the mole ratios are: Ba=3-12 moles, Ce=0.9 moles, and Nd=0.1 mole.

What is claimed is:

1. A catalytic converter, comprising:
a substrate; and
a washcoat on the substrate, comprising an oxide solid selected from the group consisting of at least one of a carrier material oxide and at least one catalyst; a first impregnation composition, and a second impregnation composition;
wherein the first impregnation composition comprises a material including one or more selected from the group consisting of Ba, Ce, Nd, Sr and Pd, and the second impregnation composition comprises a material including one or more selected from the group consisting of Ba, Ce, Nd, Sr and Pd.

2. The catalytic converter of claim 1, wherein the first impregnation composition includes a perovskite, a base metal oxide, and an alkaline earth carbonate; and the first impregnation composition is absorbed by the washcoat.

3. The catalytic converter of claim 1, wherein the first impregnation composition includes PdNO₃.

4. The catalytic converter of claim 1, wherein the first impregnation composition includes a base metal oxide selected from the group, in oxide form, consisting of at least one of Mg, Ca, Sr, Ba, Mn, Zn, Zr, Ce, Pr, Nd, Ni, Co, Fe, Rh, Pd, and rare earth elements.

5. The catalytic converter of claim 1, wherein the first impregnation composition includes a base metal oxide selected from the group consisting of at least one of CeO₂, CeZrO₂, CeZrO₂ doped with rare earth elements, NdCeO₂, and PdCeO₂.

6. The catalytic converter of claim 1, wherein the first impregnation composition includes a perovskite having a formula ABO₃; wherein A and B are cations of different size and O is an oxide anion that bonds to both A and B.

7. The catalytic converter of claim 6, wherein A from the formula ABO₃ of the perovskite is selected from the group consisting of at least one of Sr, Ba, La, Nd, and Pr.

8. The catalytic converter of claim 6, wherein B from the formula ABO₃ of the perovskite is selected from the group consisting of at least one of La, Nd, Pr, Pd, Mn, Co, and platinum group metals.

9. The catalytic converter of claim 1, wherein the first impregnation composition includes a perovskite is selected from the group consisting of BaCeO₃, NdBaCeO₃, BaCeNdO₃, SrLaMnPdO₃, and BaLaMnPdO₃.

10. The catalytic converter of claim 2, wherein the alkaline earth carbonate is selected from the group consisting of BaCO₃, SrCO₃, and witherite.

11. The catalytic converter of claim 1, wherein the second impregnation composition is absorbed by the washcoat separately from the first impregnation composition that is absorbed by the washcoat.

12. The catalytic converter of claim 11, wherein the second impregnation composition includes PdNO₃.

13. The catalytic converter of claim 11, wherein the second impregnation composition is absorbed by the washcoat after the first impregnation composition is absorbed by the washcoat.

14. The catalytic converter of claim 13, wherein the second impregnation composition includes a base metal oxide selected from the group, in oxide form, consisting of at least one of Mg, Ca, Sr, Ba, Mn, Zn, Zr, Ce, Pr, Nd, Ni, Co, Fe, Rh, and rare earth elements.

15. The catalytic converter of claim 13, wherein the second impregnation composition includes a base metal oxide selected from the group consisting of at least one of CeO₂, CeZrO₂, CeZrO₂ doped with rare earth elements, NdCeO₂, and PdCeO₂.

16. The catalytic converter of claim 15, wherein the first impregnation composition includes a perovskite having a formula ABO₃; wherein A and B are cations of different size and O is an oxide anion that bonds to both A and B.

17. The catalytic converter of claim 16, wherein A from the formula ABO₃ of the perovskite is selected from the group consisting of at least one of Sr, Ba, La, Nd, and Pr.

18. The catalytic converter of claim 17, wherein B from the formula ABO₃ of the perovskite is selected from the group consisting of at least one of La, Nd, Pr, Pd, Mn, Co, and platinum group metals.

19. The catalytic converter of claim 1, further comprising an overcoat that is deposited over the washcoat that includes the first impregnation composition and the second impregnation composition.

20. The catalytic converter of claim 19, wherein the overcoat includes a material that is selected from a group consisting of at least one of a catalyst and a carrier material oxide.

21. The catalytic converter of claim 19, wherein the overcoat includes at least one oxide solid selected from the group consisting of at least one of a carrier material oxide and a catalyst.

22. The catalytic converter of claim 20, wherein the overcoat includes the catalyst which is a metal from the platinum group metals selected from the group consisting of ruthenium, rhodium, palladium, iridium, and platinum.

23. The catalytic converter of claim 1, wherein the substrate is made from a material that is selected from the group consisting of at least one of a refractive material, a ceramic substrate, a honeycomb structure, a metallic substrate, a ceramic foam, a metallic foam, a reticulated foam, metallic, ceramic, alumina, silica alumina, silica, titania.

24. The catalytic converter of claim 1, wherein the substrate includes a characteristic selected from the group consisting of at least one of a plurality of channels, porosity, a three-dimensional support structure, in the form of beads, in the form of pellets, a ceramic honeycomb substrate, a monolithic carrier, a monolithic carrier that a plurality of parallel flow passages extending through the monolith, a monolithic carrier that a plurality of parallel flow passages extending through the monolith wherein the flow passages have shape selected from the group consisting of trapezoidal, rectangular, square, sinusoidal, hexagonal, oval, and circular, and the monolith containing from about 9 to about 1200 gas inlet openings per square inch of cross section.

25. The catalytic converter of claim 1, wherein the substrate is a metal honeycomb substrate made from a heat-resistant base metal alloy that includes iron.

26. The catalytic converter of claim 1, wherein the substrate is a ceramic honeycomb substrate that may be formed from a material selected from the group consisting of at least one of: sillimanite, zirconia, petalite, spodumene, magnesium silicates, mullite, alumina, cordierite, alumino-silicate, silicon carbide, and aluminum nitride.

27. The catalytic converter of claim 1, wherein the washcoat includes the carrier material oxide selected from the group consisting of at least one of an oxygen storage material, aluminum oxide, doped aluminum oxide, spinel, delafossite, lyonsite, garnet, perovskite, pyrochlore, doped ceria, fluorite, zirconium oxide, doped zirconia, titanium, tin oxide, and silicon dioxide.

28. A method of making a catalytic converter, the method comprising the steps of:
providing a substrate;
applying a washcoat on the substrate;
applying a first impregnation composition on the washcoat;
wherein the first impregnation composition includes a perovskite, a base metal oxide, and an alkaline earth carbonate;
drying the first impregnation composition;
applying heat to the first impregnation composition;
applying a second impregnation composition over the first impregnation composition after drying the first impregnation composition;
drying the second impregnation composition; and
applying heat to the second impregnation composition.

29. The method of claim 28, further comprising the steps of: determining an amount of Pd to use in first and second impregnation compositions; adding a first portion of the amount of Pd to the first impregnation compositions prior to said drying and said applying heat to the first impregnation compositions.

30. The method of claim 29, wherein said adding the first portion of the amount of Pb comprises a rate of about 50 g/ft³ to about 100 g/m of the washcoat.

31. The method of claim 29, wherein said applying the washcoat on the substrate comprises suspending oxide solids in water to form an aqueous slurry; and applying the aqueous slurry on the substrate.

32. The method of claim 31, further comprising the step of: adding a material selected from a group consisting of ammonium hydroxide, aluminum hydroxide, acetic acid, citric acid, tetraethylammonium hydroxide, other tetralkylammonium salts, ammonium acetate, ammonium citrate, glycerol, polyethylene glycol, polyvinyl alcohol and polymers to the aqueous slurry to adjust rheology of the aqueous slurry.

33. The method of claim 31, further comprising the step of: applying the aqueous slurry on the substrate by a method selected from the group consisting of dipping and spraying.

34. The method of claim 28, further comprising the step of: cooling the washcoat and substrate to about room temperature.
